(19) United States
(12) Patent Application Publication
(10) Pub. No.: US 2002/0069131 A1
(43) Pub. Date: Jun. 6, 2002

(54) Shopping support system and method

(75) Inventors: Masahiko Miyata, Ebina-shi (JP); Tsuneo Obara, Ebina-shi (JP); Kazuyuki Mizomichi, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 09/983,489

(22) Filed: Oct. 24, 2001

(30) Foreign Application Priority Data
Dec. 1, 2000 (JP) 2000-367623

(51) Int. Cl. G06F 17/60

(52) U.S. Cl. 705/26

(57) ABSTRACT

A requester requesting the purchase of items specifies the requested person and the desired items to be purchased in a shopping request processing system (20). The request processing system (20) notifies the requested person of the details of the shopping request. This notification includes a request number identifying the request. When the requested person inputs the request number into a guide map provider (100) installed at a store (10), the provider (100) obtains a list of the requested items in the shopping request from the request processing system (20). By referring to a map information database (108) containing a department map of the store (10), the display location of each requested item is obtained and superimposed onto the department map to create a guide map, which is then printed out.

### BACKGROUND OF THE INVENTION

1. Field of the Invention

The present invention relates to a system and method for providing guide information while touring within a facility, such as a store.

2. Description of the Related Art

Heretofore, guide signboards were placed in each department showing the category of items displayed in the respective departments or store guide maps placed at the entrances and exits of a store were intended for convenience when a user searches for the department carrying the desired item. Furthermore, the user could also ask a clerk working in the store for the location of the department carrying the desired item.

However, if the store is large or if many items are handled, there are many instances where it is difficult to find a department simply from such guide signboards or guide maps. In particular, searching for the department carrying a desired item at an unfamiliar store may involve much difficulty. For example, if a person who does not regularly go shopping is asked, such as by a family member, to purchase something, extreme effort may be required to search for even one item.

Furthermore, if one does not memorize the store department map before attempting to purchase a plurality of items, as soon as one item is acquired, one must look for the department of the next item. This can cause one to walk back and forth between the same departments resulting in an overall inefficient shopping path.

Although an example of shopping in a store was given in the above, the same problem can also occur in general, such as when touring desired attractions at an amusement park or touring desired locations within a facility having many locations.

### SUMMARY OF THE INVENTION

While taking these problems into consideration, it is therefore an object of the present invention to provide a system for assisting a person who has been asked to do shopping so that the department carrying the required item is easily found. Another object of the present invention is to provide a user with an efficient path when touring a plurality of locations within a facility or when purchasing a plurality of items.

To achieve the above-mentioned objects, a shopping support system relating to the present invention comprises a shopping request processor for accepting a shopping request that specifies desired items from a requester and for notifying a specified requested person of the shopping request, a map storage device for storing a map of a shopping space and display locations of items within that space, and a guide map information provider apparatus for receiving input of information identifying the shopping request from the requested person, for identifying on the basis of this information the desired items specified in the shopping request, for determining display locations within the shopping space of these identified and desired items by referring to the map storage device, and generating and providing to the user, guide map information that indicates on the map of the shopping space the display locations of the items.

According to this configuration, the requested person can more easily ascertain the display locations of desired items of the requester from the guide map. Furthermore, when generating guide map information, information on the desired items is obtained from information of the shopping request and used so that the requested person need not input each and every desired item.

Furthermore, the system relating to the present invention comprises a map storage device that has stored a map of a shopping space and display locations of items within that space, and a guide map information provider apparatus for accepting from a user an item list that specifies a plurality of desired items, for requesting an optimum purchasing path for purchasing the desired items included in the item list by referring to the map storage device, and generating and providing to the user, guide map information that indicates the optimum purchasing path on the map of the shopping space.

According to this configuration, information on an efficient path for purchasing a plurality of desired items can be provided to the user so that the user can perform efficient shopping even at an unfamiliar shopping space.

Furthermore, the system relating to the present invention is a system for assisting the touring task within a facility by a user and comprises a map storage device for storing a map of the facility interior and information on each location existing within the facility, a designation acceptance apparatus for accepting designation information specifying a plurality of locations to be visited from the user, and a guide map information provider apparatus for determining an optimum touring path for touring a plurality of locations specified in said designation information by referring to said map storage apparatus, generating and providing to the user, guide map information that indicates the path on said map of facility interior.

According to this configuration, the user can obtain information on an efficient path for visiting a plurality of locations. It should be noted that although the length of a path can be viewed in terms of either space or time, the present invention may include either case. This is nothing but a difference in measuring the “length” of the path by time or by spatial length.

### BRIEF DESCRIPTION OF THE DRAWINGS

FIG. 1 shows an overall configuration of one example of a system relating to the present invention.

FIG. 2 shows one example of registered information for a requester.

FIG. 3 shows one example of registered information for a requested person.

FIG. 4 shows one example of requester management information that the shopping request processing system manages.

FIG. 5 is a flowchart showing the shopping request acceptance processes.

FIG. 6 shows one example of a guide map provided to a user.

FIG. 7 is a flowchart showing the guide map creation and output processes.

### DETAILED DESCRIPTION OF THE PREFERRED EMBODIMENTS

An embodiment of the present invention will be described hereinafter with reference to the drawings.

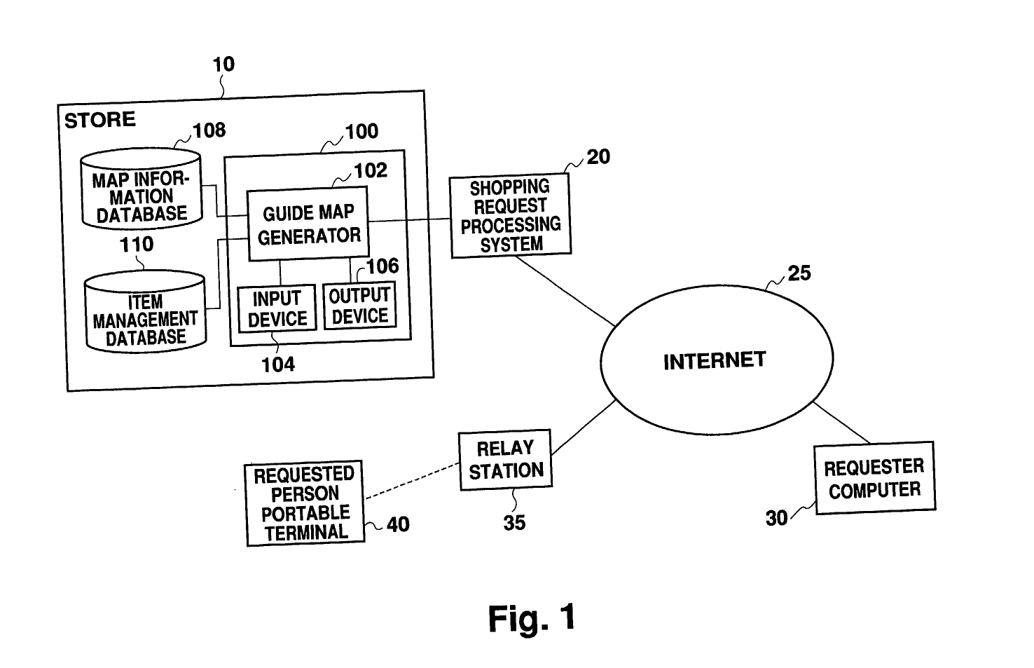

FIG. 1 shows the overall shopping support system relating to the present invention. This system provides assistance so that a person that has been asked to go shopping can perform efficient shopping at a store 10, such as when the person is asked by a family member to purchase something on the way home from work.

For this purpose, the present embodiment is first provided with a shopping request processing system 20 to act as an agency service for the shopping request. The system 20 accepts a shopping request from a requester (such as a family member at home), and a requested person (such as a person who lives in the same home and is out working) is notified of the request. Although the significance of the agency service is small since it is quicker to make a request from the requester directly to the requested person via telephone or e-mail, the present embodiment improves the convenience for the requester and requested person by connecting the request to the requested person to the in-store guide. Namely, from the information on the specified items accepted from the requester, information on the display locations or shopping route in the store for the specified items is generated and provided to the requested person so that the requested person can shop smoothly for the items.

The shopping request system 20 will first be described. The shopping request processing system 20 basically comprises a mechanism to accept a shopping request from the requester and a mechanism to notify the requested person of the details of the accepted shopping request.

Request acceptance may preferably use a web page of the WWW (World Wide Web). Namely, a web page for request acceptance is made available on an Internet 25, and the request that the requester inputs by accessing the page through a browser of a computer 30 is loaded into the shopping request processing system 20, such as by using CGI (Common Gateway Interface) programming. In this case, the shopping request processing system 20 should comprise a web server. The computer 30 of the requester may be either a fixed computer, a mobile computer, a portable information terminal, a cellular telephone, Personal Handyphone System telephone, or the like, as long as it has a web browsing function. The web page for request acceptance is provided in the shopping request processing system 20 so as to be compatible with the respective hardware configuration.

Electronic mail (e-mail) may be used for request notification to the requested person. Namely, e-mail containing the details of the accepted request is sent to the e-mail address of the requested person. The requested person can receive this request notification e-mail through which the request can be known, for example at a workplace, using a portable terminal 40 via a relay station 35. The portable terminal 40 can receive and display e-mail and may be a cellular telephone or PHS telephone.

The aforementioned is merely one example. Of course, another method besides web pages and e-mail may be used for request acceptance and request notification. However, at the present time, since request acceptance using the WWW and request notification using e-mail are unmatched in terms of reality and convenience, an example using this combination will be described hereinafter.

In the present embodiment, the person who is asked to shop (requested person) and the shopping request for one or more desired items are specified by the requester. The requester may specify at each request who is to do the shopping (requested person) or a specific person may be registered as a requested person in advance into the shopping request system 20. In this manner, the shopping request processing system 20 notifies the requested person specified by the requester, such as via e-mail or the like, of the details of the accepted request. A plurality of stores in a chain or franchise stores, such as a supermarket or convenience store, can be covered by one shopping request system 20 provided by the head office. For the acceptance of a shopping request in this case, the store used by the requester or requested person is explicitly specified or the store closest to home may be registered in advance.

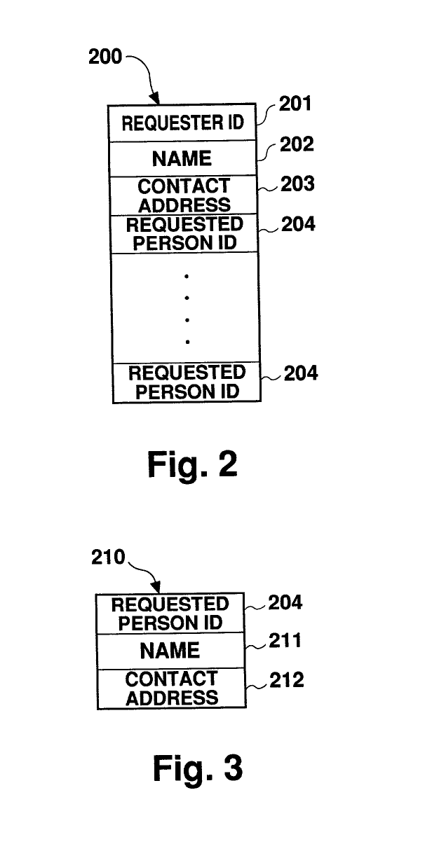

For the shopping request processing, the shopping request processing system 20 holds and manages registered information regarding the requester and requested person. One example of registered information 200 for the requester is shown in FIG. 2 and one example of registered information 210 for the requested person is shown in FIG. 3.

As shown in FIG. 2, the registered information 200 for the requester includes a requester ID 201, a name 202, a contact address 203, and a requested person IDs 204. The requester ID 201 is unique identification information assigned to the requester, and the name 202 is the name or nickname of the requester. The contact address 203 is contact information, such as the e-mail address of the requester, and is used when notifying the requester that the requested person has accepted the request or that the requested shopping has been completed. The requested person ID 204 is an ID assigned to a family member or an acquaintance who may be requested by the requester to do shopping. If it is possible for the requester to request a plurality of requested person candidates to do shopping, requested person IDs 204 for the requested person candidates are registered. The requester can then select from therein one or a plurality of requested persons, and make a request. It should be noted that the registered information 210 for the requested person shown in FIG. 3 can be referenced from the requested person ID 204.

As shown in FIG. 3, the registered information 210 for the requested person includes the requested person ID 204, a name 211, and a contact address 212. The name 211 is the name of the requested person. The contact address 212 is the address information used when notifying the requested person of a shopping request and may be an e-mail address of the requested person.

If the registered information 200 and 210 are registered for each requester and requested person, a requester can easily input the information required for a shopping request by simply inputting the requester's own ID (the input of a password may also be requested to increase security) into a web page for request acceptance that is provided by the shopping request processing system 20. The registered information 200 for a requester may be searched by requester ID so that the requested person ID 204 for the candidate requested person is obtained, and from this requested person ID 204 is obtained information on the contact address 212 of the requested person. If a plurality of requested person IDs 204 are registered in the registered information 200 for the requester, the plurality of requested person candidates are displayed on the web page for request acceptance, from which the requester can make a selection. Furthermore, a method can be used where the requester specifies the requested item by providing a web page presenting a catalog of available items and having the requester select the desired item from the catalog. It should be noted that if a requested person not registered in the registered information 200 is specified, it is sufficient to input the e-mail address of the requested person. Furthermore, besides this information, a message to the requested person can also be accepted.

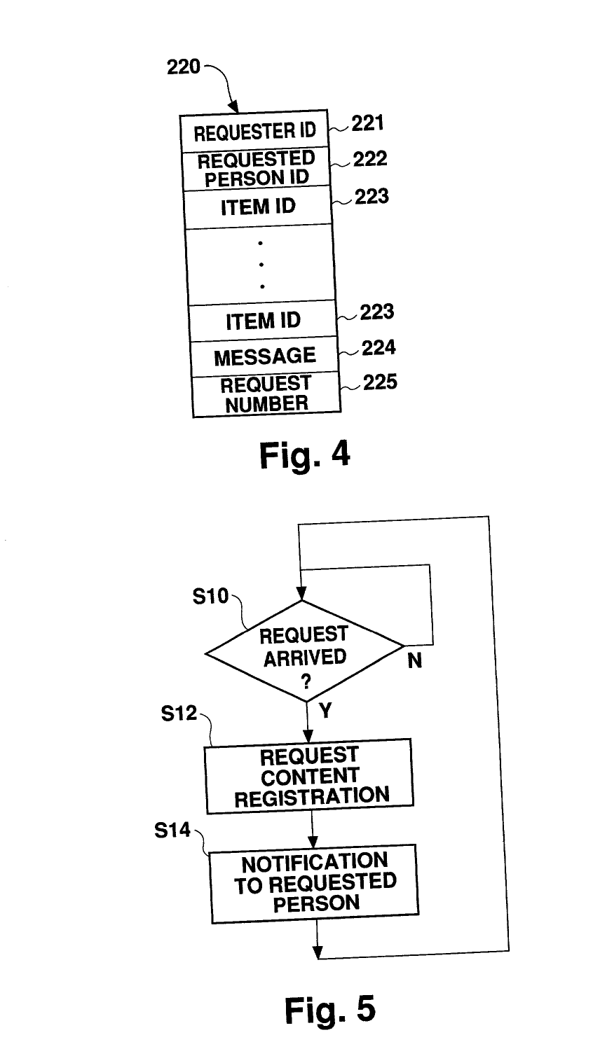

In accordance with this request application, the shopping request processing system 20 creates request management information 220 as shown in FIG. 4. The request management information 220 includes a requester ID 221 of the requester originating the relevant request, a requested person ID 222 of the requested person, an item ID 223 of at least one item specified by the requester, a message 224 from the requester to the requested person, a request number 225, and so forth. The request number 225 is an identification number of this shopping request. The request management information 220 provides request details or useful related information to the requested person and is used to notify the requester of acceptance or rejection of a request and of other information. Furthermore, the request management information 220 is transferred to a guide map provider 100 that has been installed in the store 10, and the guide map provider 100 enables a specific item of a request to be identified from the request number that was input by the requested person.

As shown in FIG. 5, the shopping request processing system 20 waits for a shopping request application from the requester (S10). When details of a request are input by the requester, the details are registered in a predetermined database (S12) as request management information 220. The requested person is then notified of the details of the request, namely, the request number 225, the item ID 223 of each requested item, the message 224, and so forth (S14).

The configuration of the shopping request processing system 20 was described above. In addition to the foregoing description, it is also possible to offer various services, such as notifying the requested person of information regarding the requested item in the shopping request, such as the price, sending an alarm notification at a predetermined timing to the requested person so that the request is not forgotten, and so forth. It should be noted that the present applicant is proposing a system relating to Japanese Patent Application No. 2000-307242, and the shopping request processing system 20 is not limited to the one illustrated in the present specification and can employ diverse shopping request processing systems including the one described in Japanese Patent Application No. 2000-307242.

Returning back to the description of the system of FIG. 1, the store 10 is provided with the guide map provider 100, a map information database 108, and an item management database 110.

The guide map provider 100 creates a guide map of the departments in a store and provides it to the user (requested person). When the guide map provider 100 receives an input of the request number of a shopping request from the requested person, a guide map is created showing the display location of the requested item in the shopping request. An input device 104 is an apparatus for accepting the input of the request number and may be equipped with a numeric keypad or touch panel. A guide map generator 102 identifies the group of the requested item from the request number that was input through the input device 104, refers to the map information database 108 and the item management database 110, and creates a guide map showing a map of the display location of each requested item. An output device 106 is an apparatus for outputting the guide map created by the generator 102. If the guide map is to be printed on paper and provided to the requested person, a printer is provided in the output device 106.

The map information database 108 holds map information of the store 10 and information on the location (display location) on the store map of various available items in the store 10. On the other hand, the item management database 110 holds and manages information on each item, such as name, category, price, quantity of inventory, and so forth. Furthermore, it is preferable to register into the item management database 110 such information on items as bargain sales and limited time offers (sale prices, time periods, and so forth) and related items of each item (substitute items, items commonly used together, and so forth). A database used by a POS (Point Of Sales) system or other sales and inventory management systems may be applied to the item management database 110.

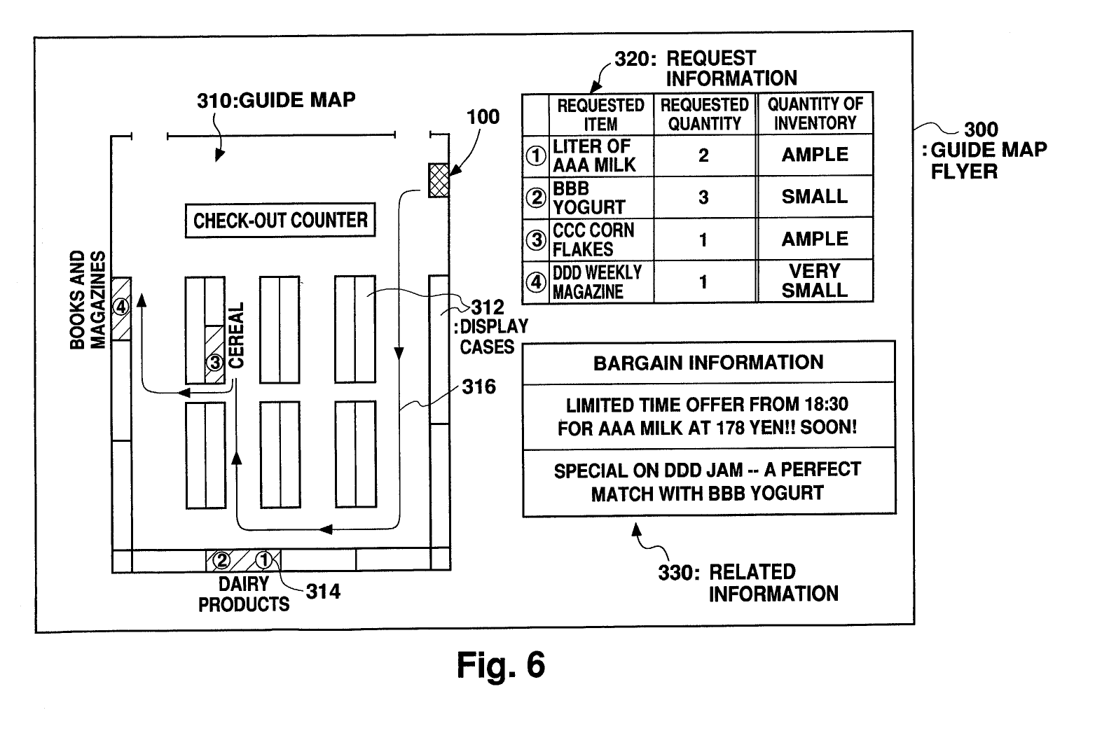

FIG. 6 shows an example of a guide map flyer (guide map information printed on paper) 300 provided by the guide map provider 100. In this example, a guide map 310, request information 320, and related information 330 are indicated on the flyer 300.

The guide map 310 displays the display location of each item specified in the shopping request to correspond to the layout map of display cases 312 in the store 10. In this example, the display case showing the requested item is indicated in a different appearance compared to the other display cases and a number label 314 for identifying each requested item is indicated at the display location. The number label 314 corresponds to the number of the item of each requested item shown in the request information 320. In this example, the item is shown as a number on the guide map 310 since the label space is small. However, if the label space is sufficiently large, the item name and other information can be indicated near the display location on the guide map 310. Also in this example, the number label 314 not only identifies the item but also indicates the recommended shopping sequence. The recommended shopping sequence may be a sequence for purchasing various requested items along the shortest path. Besides the number label 314, it is preferable to add a path label 316 indicating the shortest shopping path with an arrow or the like. In the example of the guide map 310, entrances and exits, check-out counter, guide map providers 100, and so forth, are indicated as map landmarks. The user (requested person) is able to ascertain at a glance the display locations and positional relationships of the items to be purchased and to see the path for purchasing them efficiently.

The request information 320 is a list of item names and requested quantities of items requested in the shopping request. With this list, the requested person can view the requested items together with the guide map 310, thereby helping to prevent a purchase from being forgotten. Furthermore, in this example, the current quantity of inventory of each requested item is also indicated, thereby helping the shopper to first pick up items having low inventory. When determining the recommended shopping sequence and path, it is preferable to take into consideration the information on the quantity of inventory (such as raising the priority for shopping of an item having low inventory). The quantity of inventory of the requested item may be indicated by a numeral, symbol, graphic, and so forth, near the display location of the item on the guide map 310.

The related information 330 includes useful information relating to the requested item in the shopping request, information on advertisements of the store 10, and so forth. In this example, information on upcoming limited time sales or on campaign sales of one related item to a requested item is displayed. These types of information are generated on the basis of registered information in the item management database 110. The information assists the user (requested person) during shopping and also benefits the store in terms of sales promotion.

It should be noted that the guide map flyer 300 illustrated in FIG. 6 is only one example. Since the request may be known via request notification e-mail held in the portable terminal 40, even a guide map flyer that does not include the request information 320 is sufficiently useful. Furthermore, although the related information 330 is convenient, its absence does not create a problem when ascertaining the location of a requested item. Conversely, besides the request information 320 and the related information 330, other types of information, such as advertisements, may be included in the flyer 300. Furthermore, in this example, the display locations as well as the recommended shopping path were shown. However, simply showing the display location of each requested item is often sufficiently helpful.

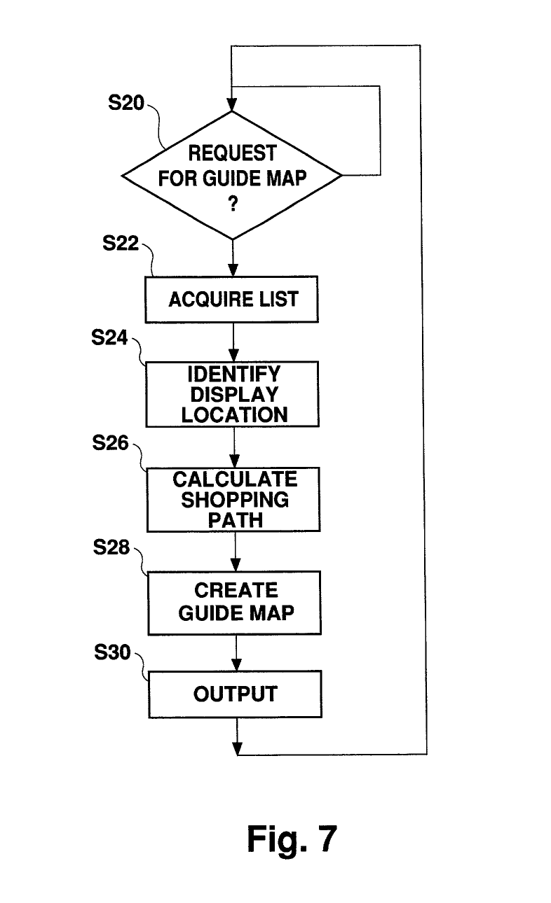

FIG. 7 shows one example of a procedure of the guide map provider 100. The provider 100 waits (S20) for the requested person to input a guide map request command through the input device 104. In the present embodiment, the guide map request is originated by inputting the request number of the shopping request. The request number is included in the shopping request notification e-mail that the requested person receives from the request processing system 20. As the request number is input in this manner, the guide map generator 102 obtains from the shopping request processing system 20 the request management information 220 (refer to FIG. 4) on the shopping request corresponding to the request number, and obtains a list of the items specified in the request (S22). Next, the guide map generator 102 obtains (S24) the display location of each specified item by referring to the map information database 108, and calculates (S26) the recommended path (sequence) to traverse each display location. The guide map generator 102 creates the guide map 310 (S28) that superimposes the display location of each requested item and the recommended path requested in this manner onto the map of the interior layout of the store 10, then prints it out on the output device 106 (S30). When providing the flyer 300 that includes the request information 320 and the related information 330, the guide map generator 102 creates the information 320 and 330 from the request management information 220 obtained from the shopping request processing system 20 and from the information obtained from the item management database 110.

The preferred embodiment of the present invention was described above. According to this embodiment, even a person unfamiliar with the store 10 can efficiently shop in the store without straying. Furthermore, in the present embodiment, the guide map is created using the list of specified items that were input for the shopping request so that troublesome tasks by the user (requested person) of inputting each and every item and so forth can be obviated.

In the above-mentioned embodiment, the requested person inputs the request number into the guide map provider 100. However, it is also possible to transfer the list of requested items to the guide map provider 100 from the portable terminal 40. The portable terminal 40 stores shopping request notification e-mail from the shopping request processor 20. The e-mail includes a list of requested items, which is transferred to the guide map provider 100. If the portable terminal 40 and the guide map provider 100 are provided with communications devices conforming to a wireless communication standard, such as Bluetooth, the item list information can be transferred without contact. If the item list is transferred from the portable terminal 40 to the guide map provider 100, communications between the shopping request system 20 and the guide map provider 100 become unnecessary.

Furthermore, in the example above, the guide map information provider 100 printed the guide map information on paper. Instead, however, the guide map information can also be provided to the portable terminal 40 as electronic data. In this case, the guide map information may be provided using e-mail or web pages.

Furthermore, the system described above is usable not only when a person requests another person to purchase something, but also for improve one's own shopping efficiency. In this case, the user specifies oneself as the requested person and performs input operations for the aforementioned shopping request. Of course, in accordance with this input, the user can use the system and obtain guide map information on a personal computer at home. However, the latest information can be obtained if the guide map information is obtained from the guide map information provider 100 at the store 10.

The example above used an example of shopping support at a store. However, the system of the present embodiment demonstrates its power in the case where efficient shopping is to be performed in a wider shopping space, such as in a inshopping mall.

Furthermore, the present invention is applicable not only to improving the efficiency of shopping tasks, but generally also of tasks in which one tours a facility. In this case, the user registers the desired places to be visited within the facility into the guide map information provider 100, such as via the Internet, so that information on an optimum touring path that reflects the latest conditions can be obtained from the guide map provider 100 that is installed within the facility or from a web page. If this system is used, it may be possible to provide a guide map in an amusement park for efficiently touring the attractions. Some attractions in the amusement park have long waiting times and other have short waiting times, and these waiting times change as time elapses. It is preferable to successively gather and manage the information on the latest estimated waiting time for each attraction and then optimize the touring path by taking the waiting time information into consideration with the map information of the amusement park.

While there has been described what are at present considered to be the preferred embodiment of the invention, it will be understood that various modifications may be made thereto, and it is intended that the appended claims cover all such modifications as fall within the true spirit and scope of the invention.

What is claimed is:

1. A shopping support system comprising:
a shopping request processor for accepting a shopping request that has information of desired items specified by a requester and for notifying a requested person of the shopping request;
a map storage apparatus that stores a map of a shopping space and display locations of each item within that space; and
a guide map information provider apparatus for receiving input of information identifying said shopping request from said requested person, for identifying desired items specified in the shopping request on the basis of the information, for determining display locations within said shopping space of identified and desired items by referring to said map storage apparatus, and for generating and providing to said user, guide map information that indicates the display locations of respective items on map of said shopping space.

2. A shopping support system according to claim 1 wherein said guide map information provider apparatus determines an optimum purchasing path for purchasing each desired item specified in said shopping request and generates guide map information to include information on the optimum purchasing path.

3. A shopping support system according to claim 1 wherein:
said shopping request processor comprises means for transmitting information on the shopping request received from said requester to a portable terminal of said requested person; and
said guide map information provider apparatus obtains information on said shopping request from the portable terminal of said requested person, and comprises means for identifying said desired items on the basis of the information.

4. A shopping support system comprising:
a map storage apparatus that stores a map of a shopping space and display locations of each item within that space; and
a guide map information provider apparatus for accepting from a user an item list that specifies a plurality of desired items, for determining an optimum purchasing path for purchasing the desired items included in said item list by referring to said map storage apparatus, and for generating and providing to said user, guide map information that indicates the optimum purchasing path on map of said shopping space.

5. A shopping support system according to claim 4 further comprising an item information management apparatus for managing related information on each item displayed within said shopping space;
said guide map information provider apparatus requests and provides to a user, related information on said desired items from said item information management apparatus to correspond to said guide map information.

6. A shopping support system according to claim 5 wherein said related information is a quantity of inventory of said items.

7. A shopping support system according to claim 5 wherein said related information is information on other items for substituting said items.

8. A shopping support system according to claim 4 wherein said guide map information provider apparatus is installed in said shopping space and comprises a printer for printing out said guide map information.

9. A facility touring support system for supporting a user when touring within a facility, comprising:
a map storage apparatus for storing a map of the facility interior and information on each relevant location existing within the facility;
a designation apparatus for accepting designation information from the user that specifies a plurality of locations to be visited; and
a guide map information provider apparatus for determining an optimum touring path for touring a plurality of locations specified in said designation information by referring to said map storage apparatus, and for generating and providing to the user, guide map information that indicates the path on map of said facility interior.

10. A shopping support method:
providing a map storage apparatus that stores a map of a shopping space and display locations of each item within that space;
accepting a shopping request that specifies desired items via communications lines from a user;
notifying a specified requested person via communications lines of information on the shopping request;
receiving an input of information identifying said shopping request from said requested person;
identifying, on the basis of the information, desired items specified in the shopping request;
determining display locations within said shopping space of identified desired items by referring to said map storage apparatus; and
generating and providing to said user, guide map information that indicates display locations of respective items on map of said shopping space.

11. A shopping support method according to claim 10 wherein:
an item information management apparatus is provided for holding and managing related information on each item displayed within said shopping space; and
in the step for generating and providing the user with said guide map information, related information on said desired items is determining from said item information management apparatus and provided to the user to correspond to said guide map information.

12. A shopping support method:
preparing a map storage apparatus that stores a map of a shopping space and a display location of each item within that space;
accepting input of an item list that specifies a plurality of desired items;
determining an optimum purchasing path for purchasing desired items included on the input list by referring to said map storage apparatus; and
generating guide map information that indicates the optimum purchasing path on map of said shopping space.

13. A shopping support method according to claim 12 wherein:
an item information management apparatus is provided for holding and managing related information on each item displayed within said shopping space; and
in the step for generating and providing the user with said guide map information, related information on said desired items is determined from said item information management apparatus and provided to the user to correspond to said guide map information.

14. A shopping support method according to claim 13 wherein said related information is a quantity of inventory of said items.

15. A shopping support method according to claim 13 wherein said related information is information on other items for substituting said items.

16. A shopping support apparatus operating in coordination with the shopping request processor that accepts a shopping request specifying desired items from a requester and notifies a requested person of the shopping request, the shopping support apparatus comprising:
a map storage apparatus that stores a map of a shopping space and display locations of each item within that space; and
a guide map information provider apparatus for receiving input of information identifying said shopping request from said requested person, for identifying desired items specified in the shopping request on the basis of the information, for determining display locations within said shopping space of identified and desired items by referring to said map storage apparatus, and for generating and providing to said user, guide map information that indicates the display locations of respective items on map of said shopping space.

17. A shopping support apparatus according to claim 16 wherein said guide map information provider apparatus determines an optimum purchasing path for purchasing each desired item specified in said shopping request and generates guide map information to include information on the optimum purchasing path.

18. A shopping support apparatus according to claim 16 further comprising an item information management apparatus for managing related information on each item displayed within said shopping space,
said guide map information provider apparatus determines and provides to a user, related information on said desired items from said item information management apparatus to correspond to said guide map information.

19. A shopping support apparatus for accepting a shopping request that specifies desired items from requester to requested person, and in accordance with a request from the requested person, for providing guide map information that indicates the display locations within the shopping space of respective desired items relating to the shopping request.
